(19) United States
(12) Patent Application Publication
(10) Pub. No.: US 2019/0249516 A1
(43) Pub. Date: Aug. 15, 2019

(54) LOW PRESSURE RESERVOIR COMPOSITE PLUG DRILL OUT

(71) Applicant: Parsley Energy, Inc., Austin, TX (US)

(72) Inventors: Braden L. RIHA, Austin, TX (US); Landon W. MARTIN, Austin, TX (US); Duncan R. HARVEY, Austin, TX (US); Alfred HERRERA, Austin, TX (US)

(73) Assignee: Parsley Energy, Inc., Austin, TX (US)

(21) Appl. No.: 15/995,769

(22) Filed: Jun. 1, 2018

Related U.S. Application Data
(60) Provisional application No. 62/630,081, filed on Feb. 13, 2018.

(51) Int. Cl. E21B 33/138; E21B 33/134; C09K 8/72; E21B 43/26

(52) U.S. Cl. CPC E21B 33/138; E21B 43/26; C09K 8/725; E21B 33/134

(57) ABSTRACT

Composite plug drill out. At least some example embodiments are methods including: drilling out a first composite plug which creates plug parts and opens a first segment having a first set of perforations through the casing; pumping diverter agent into the first segment to fluidly isolate a formation surrounding the wellbore; forcing plug parts and sand from the first segment to the surface; drilling out a second composite plug which creates plug parts and opens the second segment having a second set of perforations through the casing; pumping diverter agent into the second segment to fluidly isolate the second set of perforations against flow into the formation; and forcing plug parts and sand from the second segment to the surface.

### CROSS-REFERENCE TO RELATED APPLICATIONS

This application claims the benefit of U.S. Provisional Application Ser. No. 62/630,081 filed Feb. 13, 2018 titled “Utilizing Diverter Flake for Low Pressure Reservoir Drill Out.” The provisional application is incorporated by reference herein as if reproduced in full below.

### BACKGROUND

In exploration and recovery of hydrocarbons from underground formations, hydraulic fracturing or fracture stimulation consists of injecting fluids, proppants, and chemicals under high pressure through perforations in a casing disposed within a wellbore. The high pressure creates fractures in the formation to enable hydrocarbons to flow from the formation into the wellbore and up to the surface. In many cases the wellbore is divided into stages or segments, and each segment is individually fracture stimulated starting with the segment closest to the toe of the wellbore and working toward the heel.

Once all the segments have been fracture stimulated and plugged, the drill out operation begins. Drilling out of the plugs is performed using a work string tubing, mill, and power swivel, all while pumping viscous fluids down through the work string tubing and back up the annulus between the work string tubing and the inside diameter of the casing. Through the pumping of these fluids, the pieces of the plug created by drilling out of the plugs, along with excess proppants, are carried to the surface resulting in a clean wellbore. Once the last plug is drilled out and the pieces are carried to the surface, the work string tubing is removed and the clean wellbore will be turned into a producing well.

An issue arises, however, when the pressure of hydrocarbons within the formation is low. In such situations, the pressure of the fluid in the wellbore at the location of the perforations (the pressure caused by the height of the fluid column above the perforations) causes fluid to flow into the formation. Thus, in situations where the formation pressure is low it may be difficult to create sufficient fluid circulation within the casing to carry pieces of the plugs back to the surface.

Any method that increases the ability to circulate fluids during drill out operations associated with low pressure formations would provide a competitive advantage in the marketplace.

### BRIEF DESCRIPTION OF THE DRAWINGS

For a detailed description of example embodiments, reference will now be made to the accompanying drawings in which (not necessarily to scale):

FIG. 1 shows a side elevation, partial cross-sectional, view of a wellbore in which fracture stimulation has already taken place;

FIG. 2 shows a side elevation, partial cross-sectional, view of a drill out operation in accordance with at least some embodiments;

FIG. 2A shows a more detailed view of a portion of FIG. 2;

FIG. 3A shows a side elevation, partial cross-sectional, view of horizontal portion of the wellbore in accordance with at least some embodiments;

FIG. 3B shows a side elevation, partial cross-sectional, view of the horizontal portion of the wellbore after drilling out an example composite plug;

FIG. 3C shows a side elevation, partial cross-sectional, view of the horizontal portion of the wellbore after drilling out an example composite plug;

FIG. 4 shows a side elevation, cross-sectional view of a portion of the wellbore in accordance with at least some embodiments;

FIG. 5 shows a side elevation cross-sectional view of a portion of the wellbore in accordance with at least some embodiments; and

FIG. 6 shows a method in accordance with at least some embodiments.

### DEFINITIONS

Various terms are used to refer to particular system components. Different companies may refer to a component by different names—this document does not intend to distinguish between components that differ in name but not function. In the following discussion and in the claims, the terms “including” and “comprising” are used in an open-ended fashion, and thus should be interpreted to mean “including, but not limited to . . . ” Also, the term “couple” or “couples” is intended to mean either an indirect or direct connection. Thus, if a first device couples to a second device, that connection may be through a direct connection or through an indirect connection via other devices and connections.

“Distal end,” with respect to a segment of a casing, shall mean the portion of the segment closer to the toe of the wellbore.

“Proximal end,” with respect to a segment of a casing, shall mean the portion of the segment closer to the heel of the wellbore.

“Above” and “below” in relation to location within a wellbore shall refer to distance into the wellbore, and not necessarily depth below the Earth's surface, as some wellbores may have portions (e.g., “lateral” portions following shale layers) where increasing distance into the hydrocarbon well results in more shallow depth relative to the Earth's surface.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Various embodiments are directed to utilizing diverter agent during drill out operations for wellbores that extend into low pressure hydrocarbon reservoirs. More particularly, various embodiments are directed to methods and related systems to enable circulation of fluids during drill out operations in situations where reservoir pressure is low and circulating fluid tends to invade the surrounding formation, reducing the total volume of circulating fluid that returns to the surface. More specifically, diverter agents are used to fluidly isolate (temporarily) the perforations and/or the fractures within the surrounding formation. Once the perforations and/or fractures are fluidly isolated, sufficient circulation can be achieved to carry foreign materials (e.g., plug parts, excess proppants such as sand) back to the surface. That is, reducing the fluid invasion into the formation through the perforations using the example procedures described herein may enable increased wellhead pressure of circulating fluids, and thus increased annular velocity of circulating fluids. The increased pressure and annular velocity during cleanout operations results in better removal of plug parts and excess proppants from the inside diameter of the casing. The specification first turns to a description of a wellbore that has been fracture stimulated and plugged in order to orient the reader.

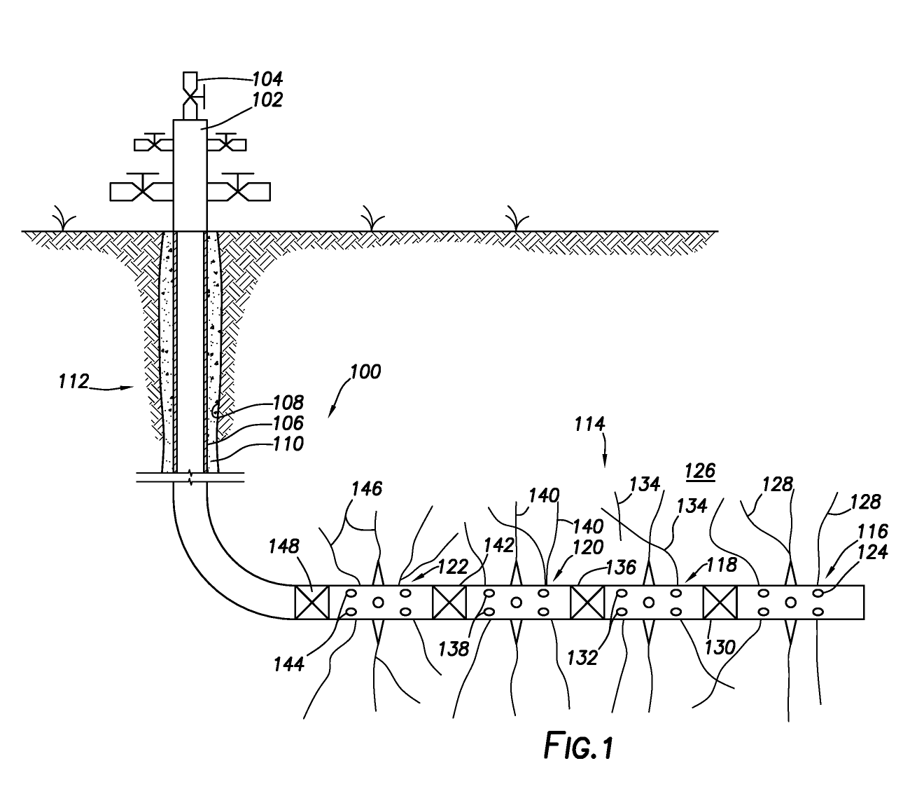

FIG. 1 shows a side elevation, partial cross-sectional, view of a wellbore 100 in which fracture stimulation has already taken place. In particular, the wellbore 100 comprises a wellhead 102 (shown in simplified schematic form) comprising one or more valves (e.g., valve 104). The wellhead 102 is coupled to a casing 106 disposed within a borehole 108. In many situations, the casing 106 is cemented in place by cement 110 in the annulus between the outside diameter of the casing 106 and the inside surface of the borehole 108. While the casing 106 and cement 110 may extend the entire length of the borehole 108, in order not to unduly complicate the figure only the upper-most vertical portion 112 of the wellbore shows the borehole and cement.

In the early days of hydrocarbon exploration and production, most wellbores were vertical, such as the vertical portion 112 of wellbore 100. In more recent times, wellbores are drilled with an initial vertical portion 112 as shown (e.g., 2000 to 4000 feet in length), and then the drill string is steered such that the wellbore extends horizontally to create a horizontal portion 114. The horizontal portion 114 may extend along hydrocarbon producing zones, such as stratified sedimentary rock containing hydrocarbons referred to as shale, shale plays, or shale formations. Because of the creation mechanism of shale formations (i.e., sedimentation), many shale formations are disposed horizontally. However, geologic forces may buckle and tilt the once horizontal shale formations, and thus wellbores that track along a shale formation are not necessarily horizontal along the entire horizontal portion 114. Nevertheless, example wellbore 100 is illustrated as having horizontal portion 114, and the horizontal portion 114 may have any suitable length (e.g., from 1000 feet to 10,000 or more). The example wellbore 100 of FIG. 1 is not to scale in either the depth or length of the horizontal portion 114. It is also noted that the drill out operations using diverter agents as discussed herein may be used in any wellbore regardless of the orientation, and thus the description in relation to a horizontal wellbore shall not be read as a limitation.

During the fracture stimulation process the horizontal portion 114 of the wellbore 100 is divided into a plurality of segments. The wellbore 100 has four example segments 116, 118, 120, and 122, but the horizontal portion 114 may have any non-zero number of segments depending on length of the horizontal portion 114 (e.g., some “long reach” horizontal wellbores may be divided into 30 or more segments). Starting with the segment 116 closest to the toe or distal end of the wellbore, by way of a wireline tool the segment 116 is perforated to create perforations 124 through the casing 106 and out into the surrounding formation 126. Once perforated, fluid, proppants, and chemicals are pumped at high pressure (i.e., above the fracture pressure of the formation 126) through the inside diameter of the casing 106, through the perforations 124, and out into the formation 126. The fracture stimulation thus creates a fracture zone comprising fractures 128 associated with the segment 116.

Once the segment 116 is fractured, a composite plug 130 is set. The composite plug 130 may take many forms. For example, the composite plug 130 may be a bridge plug that fluidly isolates the segment 116 from flow into or out of the segment 116 from within the casing 106, or the composite plug 130 may be a check-valve type plug that prevents flow from segment 118 into the segment 116 but allows flow from the segment 116 to segments above segment 116. Nevertheless, once the composite plug 130 is set, the fracture stimulation process moves to the next contiguous upstream segment 118. As before, the segment 118 is perforated to create perforations 132, and then fluid, proppants, and chemicals are pumped at high pressure (i.e., above the fracture pressure of the formation 126) through the inside diameter of the casing 106, through the perforations 132 and out into the formation 126. The fracture stimulation thus creates a fracture zone comprising fractures 134 associated with the segment 118. Once the segment 118 is fractured, a composite plug 136 is set.

The process of plugging, perforating, and hydraulically fracturing continues for each segment along the casing 106 toward the heel or proximal end of the horizontal portion 114. In the example wellbore of FIG. 1 having four segments, the fracture stimulation process thus results in perforations 138, fractures 140, and composite plug 142 all associated with segment 120. Likewise, the fracture stimulation process results in perforations 144, fractures 146, and composite plug 148 all associated with segment 122. Example segment 122 is thus fluidly isolated from the inside diameter of the casing 106 above the segment 122 by composite plug 148. Example segment 120 is fluidly isolated from segment 122 by composite plug 142. Example segment 118 is fluidly isolated from segment 120 by composite plug 136. Example segment 116 is fluidly isolated from segment 118 by composite plug 130. After setting the final composite plug 148, the equipment associated with the fracture stimulation process (e.g., wireline trucks, high pressure positive displacement pumps, fracturing tanks, etc.) is dismantled and removed from the location surrounding the wellhead 102. Rig up for drilling out of the composite plugs (sometimes referred to as drill out operations) and the initial flow back may begin.

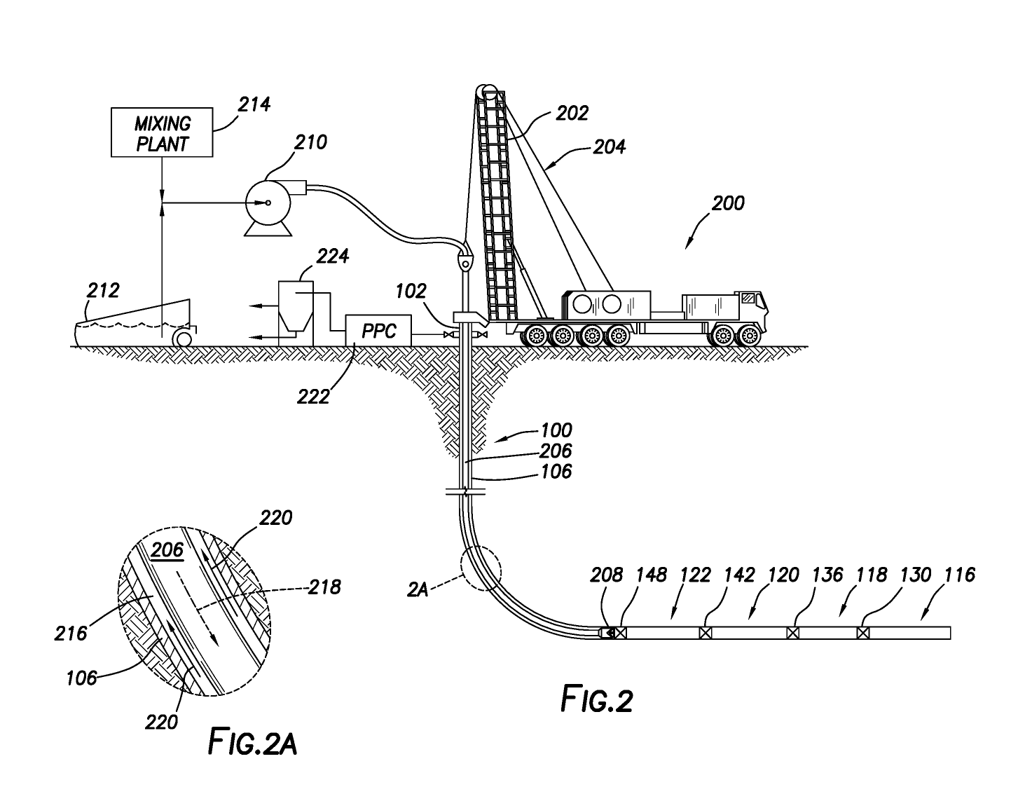

FIG. 2 shows a simplified side elevation, partial cross-sectional, view of a drill out operation in accordance with at least some embodiments. FIG. 2 is not to scale. In particular, FIG. 2 shows a workover rig 200 that comprises a derrick 202 having one or more lines 204 used to raise and lower various objects out of and into the wellbore 100, and in particular out of the wellhead 102. In the example operation, the workover rig 200 suspends a tubing string 206 (created from individual pipe sections) within the inside diameter of the casing 106. The tubing string 206 has a drill bit 208 disposed at the distal end of the tubing string 206. The inside diameter of the tubing string 206 is fluidly coupled to a pump 210. Pump 210 is illustratively drawn as a centrifugal pump, but any suitable pump may be used. In the example system, the pump 210 takes suction from a tank 212 storing fluid (e.g., fresh water). Moreover, and as shown, the supply of fluid to the pump 210 may be provided in part from a mixing plant 214 (shown in block diagram form) which mixes, stores, and meters out various fluids (e.g., diverter agent suspended in fluid) to assist the drill out operation. Fluids that are pumped from the pump 210 and through the inside diameter of the tubing string 206 exit jets or ports on the drill bit 208 (the ports not specifically shown) and return to the surface in the annulus 216 between the outside diameter of the tubing string 206 and the inside diameter of the casing 106 (as shown in the magnified section of FIG. 2A). In particular, in the magnified section the fluid flow within the inside diameter of the tubing string 206 toward the drill bit 208 is shown by dashed lines 218, and the fluid flow back toward the surface in the annulus 216 is shown by solid line 220.

Fluid, and objects carried by the fluid, exit the wellhead 102 and flow to a plug-parts catcher 222 (shown in block diagram form). As the name implies, the plug-parts catcher 222 separates the larger objects, mostly plug parts created by drilling out the composite plugs 130, 136, 142, and 148 (as discussed more below). After flowing through plug-parts catcher 222, the fluid flow may be run through a sand separator 224 (illustratively shown as a vortex separator) and then to storage tanks (not shown) for temporary storage and later disposal.

In the example system using workover rig 200, at certain times the tubing string 206 is rotated at the surface (e.g., by a Kelly drive unit (not specifically shown) associated with the workover rig 200). The rotation of the tubing string 206 likewise rotates the drill bit 208 to enable drilling of the composite plugs. In other example drill out operations, the workover rig and tubing string 206 may be replaced with a coiled tubing system such that the tubing string 206 remains rotationally stationary throughout the drill out process, and where the drill bit 208 is rotated by a downhole fluid motor turned by pressure of the fluid pumped through the inside diameter of the coiled tubing. The specification from this point forward assumes a system where the tubing string 206 is rotated at the surface to cause rotation of the drill bit 208; however, one of ordinary skill in the art, with the benefit of this disclosure, could likewise implement the drill out operations with a coiled tubing system using a downhole fluid motor. The specification now turns to a detailed description of the drill out operations in accordance with the example embodiments.

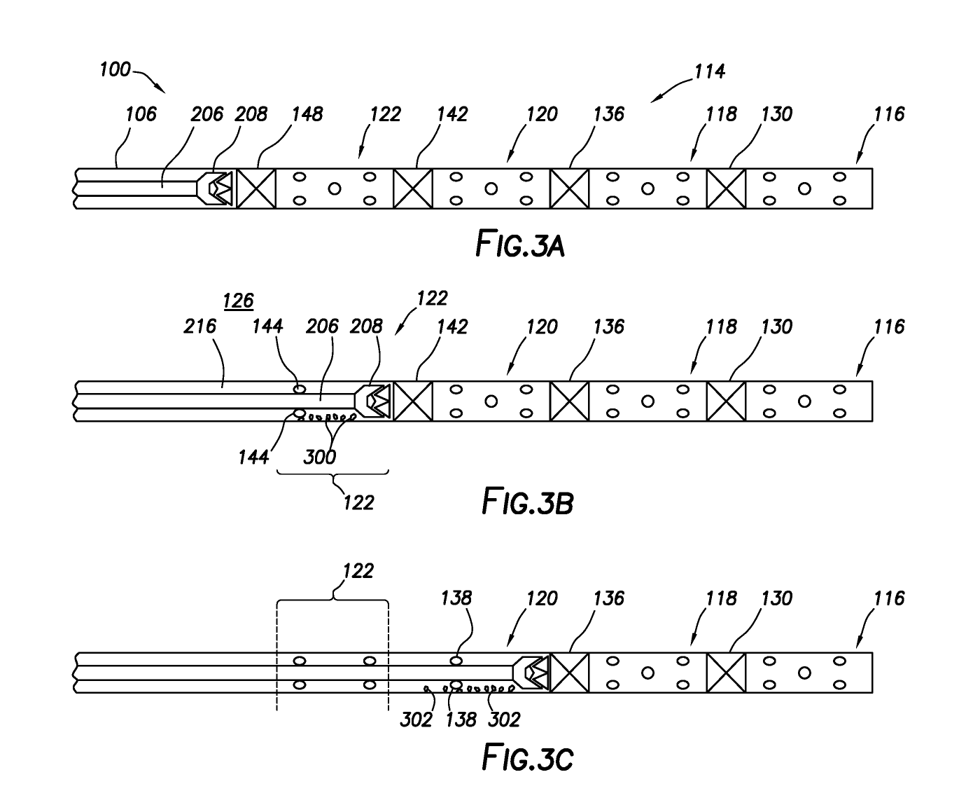

FIG. 3A shows a side elevation, partial cross-sectional, view of the horizontal portion 114 of the wellbore in accordance with at least some embodiments. In particular, FIG. 3A shows the example horizontal portion 114 of wellbore 100 including segments 116, 118, 120, and 122 having composite plugs 130, 136, 142, and 148 fluidly isolating the segments from each other and from the inside diameter of the casing 106 above the composite plug 148. The fractures are not shown so as not to unduly complicate the figure. Also visible in FIG. 3A is a portion of the tubing string 206 having drill bit 208 disposed on a distal end of the tubing string 206. The example drill bit 208 is shown as a roller-cone bit, but any drill bit or milling system suitable to drill out the composite plugs may be used.

The example method proceeds to drill out the composite plug 148. In accordance with example embodiments, during the period of time that the tubing string 206 is rotating and the drill bit 208 is drilling out the composite plug 148, fluid is pumped (e.g., by pump 210 (FIG. 2)) through the inside diameter of the tubing string 206 at a sufficient pressure to provide suitable fluid flow to cool the drill bit 208 and to carry cuttings away from the cutting faces and/or cones of the drill bit 208. For the first composite plug in the horizontal portion 114, the flow rate through the drill bit 208 may also be sufficient to carry the plug parts back to the surface (as there are no perforations above the first composite plug 148 with which to contend).

FIG. 3B shows a side elevation, partial cross-sectional, view of the horizontal portion 114 of the wellbore after drilling out the example composite plug 148. In particular, drilling out the composite plug 148 (not shown in FIG. 3B) removes or destroys the composite plug and creates plug parts 300. Likewise, drilling out the composite plug 148 exposes or opens the segment 122 (including perforations 144 (only two visible)) to the inside diameter of the casing 106 above the segment 122.

In the related-art, after the drill out of composite plug 148 a high volume of fluid is pumped down through the inside diameter of the tubing string 206 and then up through the annulus 216 to create fluid circulation designed to carry the plug parts and excess proppants back to the surface. However, in situations where the formation 126 surrounding the example segment 122 has insufficient pressure, the related-art attempt to circulate fluid results in invasion of circulating fluid into the formation, loss of circulating fluid, and/or an inability to create sufficient flow to achieve the desired result of carrying the plug parts and excess proppants back to the surface. Moreover, depending on the size of the plug parts in the relation to the size of the perforations, the fluid invasion into the formation may force plug parts into the perforations and/or formation, thus further exacerbating later attempts to produce hydrocarbons from the formation.

In contrast to the related-art methods, in accordance with example embodiments as soon as the drill bit 208 removes the composite plug 148 and thus fluidly couples the inside diameter of the casing 106 to the example segment 122, the formation is fluidly isolated by pumping diverter agent suspended in liquid into the segment 122. Any of a number of surface indications may be used to determine when the drill bit 208 has removed the composite plug 148. For example, a drop in weight-on-bit associated with the drill bit 208 (as determined by increased weight held by the lines 204 (FIG. 2) of the workover rig 200 (FIG. 2)) may indicate the composite plug has been fully removed. Other example indications may include a reduction in pressure at the wellhead 102 (indicating fluid loss into the formation rather than return by way of the annulus 216), and/or a drop in fluid flow returning to the surface by way of the annulus 216. Regardless of how the determination regarding removal of the composite plug 148 is made, again the next step in the example method is to fluidly isolate the formation surrounding the borehole at the location of the segment 122 by the pumping diverter agent suspended in liquid into the segment 122. That is, a predetermined volume or “pill” of combined diverter agent and fluid (mixed in the mixing plant 214 (FIG. 2)) is pumped down through the inside diameter of the tubing string 206, out through the ports of the drill bit 208, and into the segment 122. An example of the type and amount of diverter agent and fluid is discussed more below.

In accordance with some example embodiments, the pressure and/or flow rate of the pill of fluid (in which the diverter agent is suspended) is less than the flow rate used for circulating for purposes of forcing plug parts back to the surface. Moreover, the pressure of the fluid in which the diverter agent is suspended is lower than a fracture pressure of the formation 126. Nevertheless, the diverter agent (suspended in the fluid) flows into the segment 122 and lodges in the fractures 146 (FIG. 1) of the formation 126 surrounding the segment 122 and/or lodges in the perforations 144 of the segment. Once placed, the diverter agent reduces or prevents fluid flow through the perforations and/or reduces or prevents flow into the formation.

Either prior to pumping the diverter agent, during pumping of the diverter agent, and/or after pumping the diverter agent, the tubing string 206 and drill bit 208 are advanced within the horizontal portion 114. In some cases the drill bit 208 may be placed close to (e.g., within one foot) the next composite plug, or the drill bit 208 may abut the next composite plug (e.g., composite plug 142 as shown in FIG. 3B). After placing the drill bit 208 proximate to the next composite plug 142, plug parts 300 are forced back to the surface by circulating fluid down the inside diameter of the tubing string 206 and out the ports of the drill bit 208. That is, the example method circulates fluid down the tubing string 206 and up the annulus 216 between the outside diameter of the tubing string 206 and the inside diameter of the casing 106. The circulating fluid carries plug parts 300 and excess proppants (e.g., sand) from the first segment 122 to the surface with reduced or eliminated loss of fluid into the low pressure formation 126 surrounding the segment 122.

Still referring to FIG. 3B, the example method proceeds to drill out composite plug 142. As before, during the period of time that the tubing string 206 is rotating and the drill bit 208 is drilling out the composite plug 142, fluid is pumped through the inside diameter of the tubing string 206 at a sufficient pressure to provide suitable fluid flow to cool the drill bit 208 and to carrying cuttings away from the cutting faces and/or cones of the drill bit 208. In related-art operations where formation pressure is low, the fluid flow to cool the drill bit 208 and carry cuttings away from the cutting faces and/or cones would be lost, in whole or in part, into the formation through the perforations 144 of the previously exposed segment 122. However, in the various embodiments the formation surrounding the borehole associated with segment 122 is fluidly isolated because the previously placed diverter agent, and thus loss of fluid flow during the drill out of example composite plug 142 is reduced or eliminated. Moreover, as discussed more below, the diverter agent may also act as a physical barrier or plug of the perforations 144, reducing the chances of the plug parts being forced into the perforations 144 and/or the fractures 146 of segment 122. Thus, in example drill out operations the flow rate through the drill bit 208 during removal of the composite plug 142 may also be sufficient to carry the plug parts and excess proppants back to the surface.

FIG. 3C shows a side elevation, partial cross-sectional, view of the horizontal portion 114 of the wellbore after drilling out the example composite plug 142 (FIG. 3B). In particular, drilling out the composite plug 142 removes the composite plug 142 and creates plug parts 302. Likewise, drilling out the composite plug 142 exposes or opens the segment 120 (including perforations 138 (only two visible)) to the inside diameter of the casing 106 above the segment 120. As before, as soon as the drill bit 208 removes the composite plug 142 to fluidly couple the inside diameter of the casing 106 to the example segment 120, the formation surrounding the segment 120 is fluidly isolated by pumping diverter agent suspended in liquid into the segment 120. That is, diverter agent mixed in the mixing plant 214 (FIG. 2) is pumped down through the inside diameter of the tubing string 206, out through the ports of the drill bit 208, and into the segment 120. The pressure and flow rate of fluid in which the diverter agent is suspended may be less than the flow rate used for circulating for purposes of forcing plug parts back to the surface. Moreover, the pressure of the fluid in which the diverter agent is suspended is lower than a fracture pressure of the formation 126. Nevertheless, the diverter agent lodges in the fractures 140 (FIG. 1) of the formation 126 surrounding the segment 120 and/or lodges in the perforations 138 of the segment 120. Once placed, the diverter agent reduces or prevents fluid flow through the perforations and/or reduces or prevents fluid flow into the formation 126. Examples of type and amount of diverter agent are discussed more below.

Either prior to pumping the diverter agent, during pumping of the diverter agent, and/or after pumping the diverter agent, the tubing string 206 and drill bit 208 are advanced within the horizontal portion 114 to be close to abut the next composite plug (e.g., composite plug 136 as shown in FIG. 3C). Thereafter, the plug parts 302 created by drilling out of composite plug 142 are forced back to the surface by circulating fluid down the inside diameter of the tubing string 206 and out the ports of the drill bit 208. That is, the example method then circulates fluid down the tubing string 206 and up the annulus 216 between the outside diameter of the tubing string 206 and the inside diameter of the casing 106. The circulating fluid carries plug parts 302 and excess proppants (e.g., sand) from the segment 120 to the surface with reduced or eliminated loss of fluid into the low pressure formation 126 surrounding the segment 120.

The example method continues with the drill out of composite plug 136 and segment 118, and then with respect to composite plug 130 and segment 116. The only modification is with respect to the distal-most segment 116, which does not have a composite plug on the distal end thereof. During the period of time when the plug parts associated with composite plug 130 are being forced to the surface, the drill bit 208 may be placed just beyond the segment 116 (e.g., proximate the terminal end or “rat hole” of the wellbore). Again, while the example method is discussed only with respect to wellbore 100 having four segments, any non-zero number of segments may be implemented (e.g., 30 segments). The specification now turns to a description of an example the diverter agent.

In example embodiments the diverter agent may take the form of polylactic acid (PLA), which may be obtained from any suitable source, such as BIOVERT® brand biodegradable diverter agents available from Halliburton Energy Services, Inc. of Houston, Tex. Diverter agents in the form of PLA form a temporary plug or seal that dissolves or degrades over time as a function of the downhole temperature. In many cases, the plug or seal created by PLA may remain in place for two or three days, slowly dissolving or degrading over time. Once degraded or dissolved the perforations and/or fractures are again fluidly coupled to the inside diameter of the casing 106. Use of the diverter agent in the form of PLA creates no limitation on what further fluids may be pumped downhole during the drill out; by contrast, use of saturated brine fluid as a means to limit fluid loss to the formation restricts use of fresh water (because the fresh water dissolves the brine).

Diverter agent in the form of PLA comes in several shapes and sizes. For example, in some forms the diverter agent comprises spheroids of PLA having an average diameter of a few millimeters to a few tenths of a millimeter (e.g., fine powder). In other forms the diverter agent comprises flakes of PLA having largest dimensions on the order of 5 millimeters to a few tenths of a millimeter (e.g., similar to a fine powder). The selection of diverter agent shape (e.g., spheroids and/or flakes) and the size may vary depending on the situation. From the standpoint of fluid loss into the formation during fluid circulation intended to carry plug parts and excess proppants to the surface, so long as fluid flow through the perforations and into the formation is reduced or eliminated then sufficient flow volume and velocity of the fluid in the annulus 216 (FIG. 2) may be maintained. In situations where the fluid loss is the primary concern, the size and shape of the diverter agent may be selected such that the diverter agent flows through the perforations and out into the formation to fluidly isolate the formation.

FIG. 4 shows a side elevation, cross-sectional view of a portion of the wellbore in accordance with at least some embodiments. FIG. 4 is not to scale. In particular, FIG. 4 shows a short horizontal portion 114 of the wellbore 100. Casing 106 is shown cemented in place within the wellbore 100 by way of cement 110. Visible in FIG. 4 are four perforations 400 (only the lower two specifically marked) through the casing 106, which perforations 400 could be any of the example perforations 124, 132, 138, or 144 (FIG. 1). Moreover, FIG. 4 shows fractures 402 extending out into the formation 126 from the perforations 400, which fractures 402 could be any of the example fractures 128, 134, 140, or 146 (FIG. 1) discussed above. The size and shape of the perforations vary from wellbore to wellbore, and company to company. For example, the perforations 400 may be circular and have diameters between and including 0.2 inches and 0.75 inches.

In accordance with some example embodiments, the shape and size of the diverter agent is selected to pass through the perforations 400 and flow out into fractures 402 of the formation 126 before becoming lodged. In particular, FIG. 4 shows diverter agent 404 lodged in fractures 402 of the formation 126. That is, in example embodiments the method comprises pumping diverter agent having a particle size that lodges in fractures of the formation surrounding the wellbore 100 to fluidly isolate against fluid flow into the formation. In situations where the diverter agent 404 lodges in the formation 126, the size and shape is selected to be an order of magnitude or more smaller than the smallest dimension of the perforations 400. More specifically, size of the diverter agent may be selected based on the expected geological make-up of the rock structure and expected fracture width. In some cases, diverter agent having small spheroidal shapes may work best for lodging in the fractures 402 of the formation 126. In other cases combinations of diverter agents have spheroidal shapes and flake shapes may be used.

In yet still other cases, while fluid loss may be a concern, another consideration may be plug parts falling into or being forced into the perforations 400 and or fractures 402. In particular, in many cases the plug parts created by drilling out a composite plug will be on the order of dime- to nickel-size pieces. In cases where the perforations are on the larger end of the spectrum (e.g. 0.75 inches perforations), plug parts may find their way into the perforations 400 and become lodged, which may adversely affect future hydrocarbon production. Thus, in other example embodiments diverter agent may be selected such that the diverter agent flows into and forms a mechanical plug covering or blocking the perforations. The mechanical plug may thus prevent plug parts from falling into the perforations or otherwise being forced into the perforations. The mechanical plug of diverter agent may alone, or in combination with other diverter agent that flows into the fractures, fluidly isolate the formation.

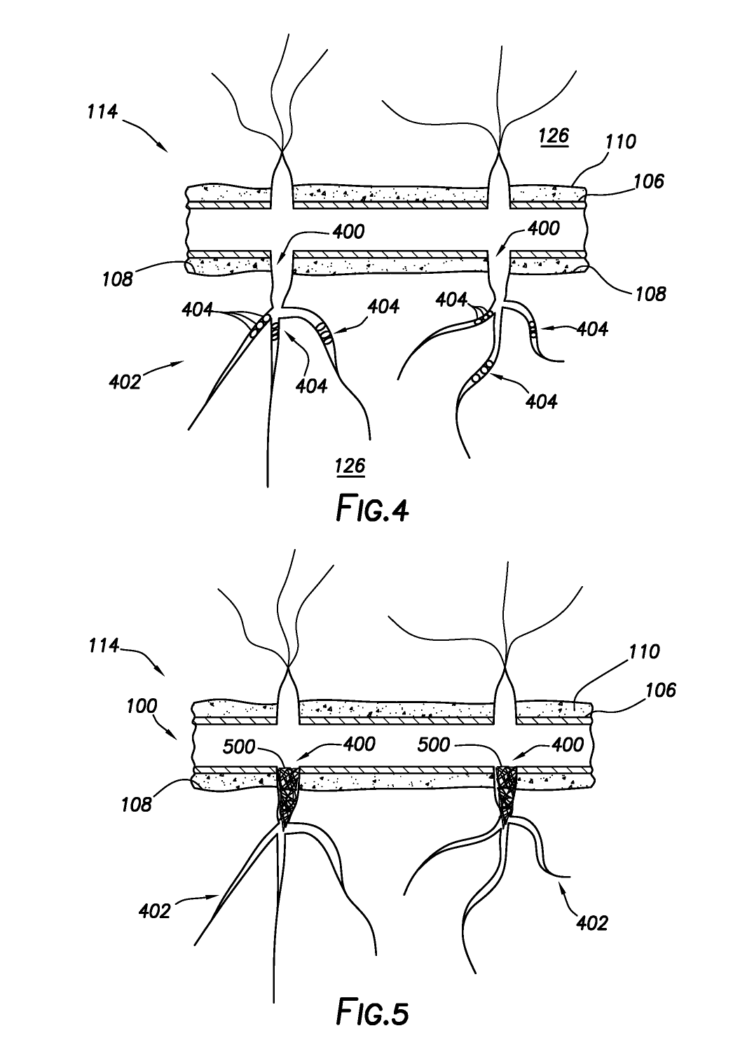

FIG. 5 shows a side elevation, cross-sectional view of a portion of the wellbore in accordance with at least some embodiments. FIG. 5 is not necessarily to scale. In particular, FIG. 5 shows a short horizontal portion 114 of the wellbore 100. Casing 106 is shown cemented in place within the wellbore 100 by way of cement 110. Visible in FIG. 5 are four perforations 400 (only the lower two specifically marked) through the casing 106, which perforations 400 could be any of the example perforations 124, 132, 138, or 144 (FIG. 1) discussed above. Moreover, FIG. 5 shows fractures 402 extending out into the formation 126 from the perforations 400, which fractures 402 could be any of the example fractures 128, 134, 140, or 146 (FIG. 1) discussed above.

In accordance with some example embodiments, the shape and size of the diverter agent is selected to lodge within and occlude the perforations 400. In particular, FIG. 5 shows diverter agent 500 lodged in the perforations 400. That is, in example embodiments the method comprises pumping diverter agent having a particle size and/or flake size that lodges in the perforations 400 to fluidly isolate against fluid flow into the formation and to provide a physical barrier against plug parts falling into or being forced into the perforations 400 (e.g., larger perforations, such as perforations having diameters of 0.75 inches). In situations where the diverter agent 404 lodges in and occludes the perforations 400, the size and shape is selected to be conducive to lodging in the perforations 400, an in many cases having dimensions of between and including 0.5 and 1.5 times the largest dimension of the perforation 400 (e.g., the diameter for circular perforations). In some cases, diverter agent having a large flake form may work best for lodging in and occluding the perforations 400. In other cases combinations of diverter agents have flake forms and spheroidal shapes may be used.

It is noted that selecting diverter agent size and shape to lodge in and occlude the perforations is not mutually exclusive with diverter agent lodging in the fractures 402. That is, diverter agent may be selected that includes diverter agent selected to lodge within the fractures 402 and diverter agent selected to lodge in and occlude the perforations 400 may be used (i.e., combinations of FIGS. 4 and 5). Moreover, even in situations where diverter agent is selected for lodging in and occluding perforations, some of the diverter agent may nevertheless be forced out into the formation (e.g., the initially arriving flakes and/or spheroids). In some cases the diverter agent in a pill may be divided. For example, with respect to a single set of perforations 400 in a segment, initially diverter agent having a particle size that lodges in fractures of the formation may be pumped, and later in the same pill diverter agent having particle sizes that lodge and occlude in the perforations may be pumped, all to enable both good fluid isolation of the formation and sufficient occlusion of the perforations. Alternately, the diverter agent pill may initially contain diverter agent in flake form (e.g., to initially lodge in the larger size spaces closer to and/or within the perforations), and then the pill may contain diverter agent in smaller form (e.g., smaller flake, or small spheroidal form) to lodge within the larger flakes to form a better seal and/or better occlusion of the perforation.

Selecting the size and shape of the diverter agent may thus be based on expected issues to be obviated with the diverter agent. Once the size and shape (or combinations of size and shape) are selected, the number of perforations in each segment or stage is determined. In example embodiments the number of perforations indicates the quantity of combined diverter agent and fluid (e.g., in pounds) pumped per pill. In example operations, 1 pound (lb.) of combined diverter agent and fluid may be pumped for each perforation in the segment. Next, a determination is made regarding specific gravity of diverter flake material to determine the viscosity used for suspending the diverter flake material. In an example operation, a specific gravity of 1.28 for the diverter agent in flake form was used with an 80 viscosity fluid. A mixing plant 214 (FIG. 2) with paddle-type mixers was used to mix the solution prior to and during pumping, the mixing to reduce settling of the diverter agent. Capacities of mixing plants vary, but in the example operation a mixing plant having a 15 barrel tank was used. Thus, in one example operation for a segment having 30 perforations, 50 lbs. of diverter agent (in flake form) was mixed with five barrels of viscous fluid achieving a 0.25 (parts per gallon (ppg)) concentration. For the example operation, the amount of diverter agent and fluid (again for a segment with 30 perforations) resulted in pumping three barrels of diverter agent to achieve the 1 lb. of combined diverter agent and fluid per perforation. The specifics may be varied depending on the diverter agent poundage observed in returns from the wellbore.

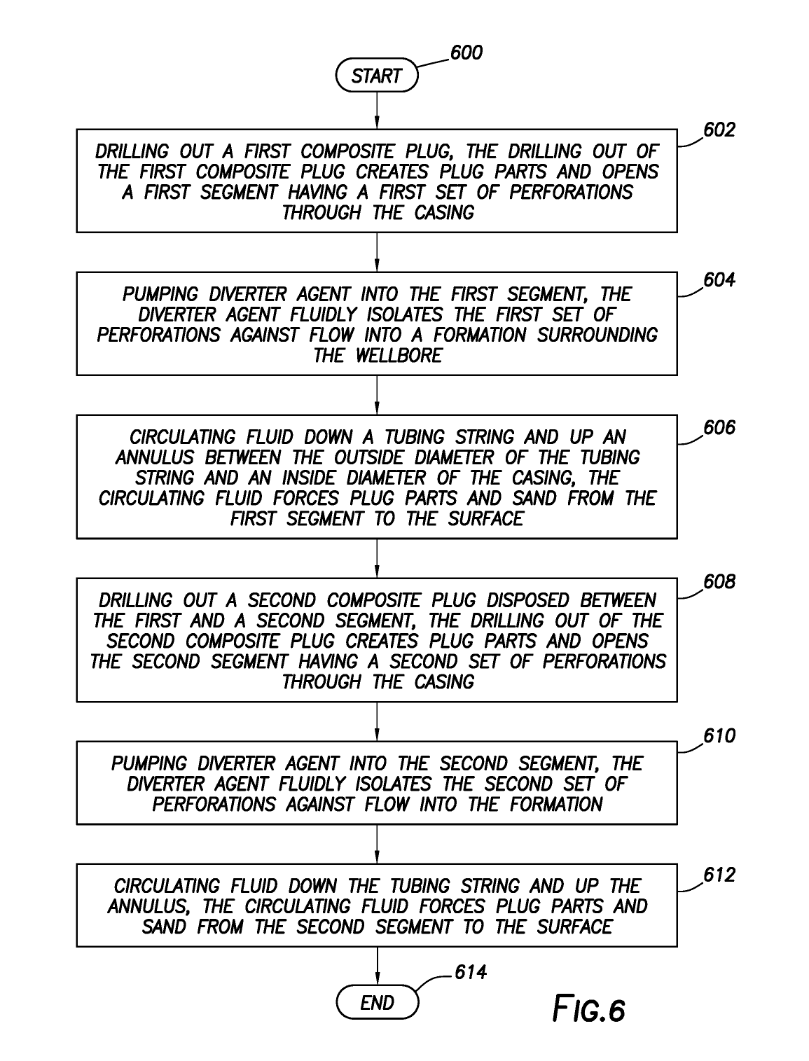

FIG. 6 shows a method in accordance with at least some embodiments. In particular, in a wellbore in which fracture stimulation has already taken place resulting in a plurality of segments with perforations through a casing, the plurality of segments separated by a composite plug between each segment, the method starts (block 600) and comprises: drilling out a first composite plug, the drilling out of the first composite plug creates plug parts and opens a first segment having a first set of perforations through the casing (block 602); pumping diverter agent into the first segment, the diverter agent fluidly isolates the first set of perforations against flow into a formation surrounding the wellbore (block 604); circulating fluid down a tubing string and up an annulus between the outside diameter of the tubing string and an inside diameter of the casing, the circulating fluid forces plug parts and sand from the first segment to the surface (block 606); drilling out a second composite plug disposed between the first segment and a second segment, the drilling out of the second composite plug creates plug parts and opens the second segment having a second set of perforations through the casing (block 608); pumping diverter agent into the second segment, the diverter agent fluidly isolates the second set of perforations against flow into the formation (block 610); and circulating fluid down the tubing string and up the annulus, the circulating fluid forces plug parts and sand from the second segment to the surface (block 612). The method ends (block 614), likely to be continued for additional segments along the wellbore.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. In a wellbore in which fracture stimulation has already taken place resulting in a plurality of segments with perforations through a casing, the plurality of segments separated by a composite plug between each segment, a method of comprising:
drilling out a first composite plug, the drilling out of the first composite plug creates plug parts and opens a first segment having a first set of perforations through the casing;
pumping diverter agent into the first segment, the diverter agent fluidly isolates the first set of perforations against flow into a formation surrounding the wellbore;
circulating fluid down a tubing string and up an annulus between the outside diameter of the tubing string and an inside diameter of the casing, the circulating fluid forces plug parts and sand from the first segment to the surface;
drilling out a second composite plug disposed between the first segment and a second segment, the drilling out of the second composite plug creates plug parts and opens the second segment having a second set of perforations through the casing;
pumping diverter agent into the second segment, the diverter agent fluidly isolates the second set of perforations against flow into the formation; and
circulating fluid down the tubing string and up the annulus, the circulating fluid forces plug parts and sand from the second segment to the surface.

2. The method of claim 1 wherein pumping diverter agent into the first segment further comprises pumping diverter agent in flake form suspended in liquid.

3. The method of claim 2 wherein pumping diverter agent into the second segment further comprises pumping diverter agent in flake form suspended in liquid.

4. The method of claim 1 wherein pumping diverter agent into the first segment further comprises pumping polylactic acid in flake form suspended in liquid.

5. The method of claim 4 wherein pumping diverter agent into the second segment further comprises pumping diverter agent in flake form suspended in liquid.

6. The method of claim 1 wherein pumping diverter agent into the first segment further comprises pumping diverter agent suspended in liquid, the diverter agent having a particle size that lodges in fractures of a formation surrounding the wellbore to fluidly isolate the formation from fluid flow into the formation.

7. The method of claim 6 wherein pumping diverter agent into the second segment further comprises pumping diverter agent suspended in liquid, the diverter agent having a particle size that lodges in fractures of the formation associated with the second set of perforations to fluidly isolate the formation from fluid flow into the formation.

8. The method of claim 1 wherein pumping diverter agent into the first segment further comprises pumping diverter agent suspended in liquid, the diverter agent having a particle size that lodges in and occludes each perforation of the first set of perforations.

9. The method of claim 8 wherein pumping diverter agent into the second segment further comprises pumping diverter agent having a particle size that lodges in and occludes each perforation of the second set of perforations.

10. The method of claim 1 wherein circulating fluid associated with the first segment further comprises circulating fluid such that pressure at the first segment is less than a fracture pressure of the formation.

11. The method of claim 1 wherein circulating fluid associated with the first segment further comprises circulating fresh water.

12. In a wellbore in which fracture stimulation has already taken place resulting in a plurality of segments with perforations through a casing, the segments separated from each other by a plurality of composite plugs within the casing, a method of comprising:
drilling out a first composite plug, the drilling out of the first composite plug creates first plug parts and opens a first segment having a first set of perforations through the casing;
fluidly isolating a formation surrounding the borehole associated with the first set of perforations by pumping diverter agent suspended in liquid into the first segment;
forcing the first plug parts and sand from the first segment to the surface by circulating fluid down a tubing string and up an annulus between the outside diameter of the tubing string and an inside diameter of the casing;
drilling out a second composite plug disposed between the first segment and a contiguous second segment, the drilling out of the second composite plug created second plug parts and opens a second segment having a second set of perforations through the casing;
fluidly isolating the formation surrounding the borehole associated with the second set of perforations by pumping diverter agent suspended in liquid into the second segment; and
forcing the second plug parts and sand from the second segment to the surface by circulating fluid down the tubing string and up the annulus.

13. The method of claim 12 wherein fluidly isolating the formation surrounding the borehole associated with the first set of perforations further comprises pumping diverter agent in at least one selected from a group comprising: diverter agent in flake form suspended in liquid; and diverter agent in spheroid form suspended in liquid.

14. The method of claim 12 wherein fluidly isolating the formation surrounding the borehole associated with the first set of perforations further comprises at least one selected from a group comprising: pumping polylactic acid in flake form suspended in liquid; and pumping polylactic acid in spheroid form suspended in liquid.

15. The method of claim 12 wherein fluidly isolating the formation surrounding the borehole associated with the first set of perforations further comprises pumping diverter agent having a particle size that lodges in fractures of a formation surrounding the wellbore to fluidly isolate the formation against fluid flow into the formation.

16. The method of claim 12 wherein fluidly isolating the formation surrounding the borehole associated with the first set of perforations further comprises pumping diverter agent having a particle size that lodges in and occludes each perforation of the first set of perforations.

17. The method of claim 12 wherein forcing the first plug parts and sand from the first segment to the surface further comprises circulating fluid such that pressure at the first segment is less than a fracture pressure of the formation.

18. The method of claim 12 wherein forcing the first plug parts and sand from the first segment to the surface further comprises circulating fresh water.
